(19) United States
(12) Patent Application Publication
(10) Pub. No.: US 2010/0103312 A1
(43) Pub. Date: Apr. 29, 2010

(54) Video Display Device, Video Signal Processing Device, and Video Signal Processing Method

(76) Inventor: Noriyuki Matsuhira, Tama-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/603,328

(22) Filed: Oct. 21, 2009

(30) Foreign Application Priority Data
Oct. 27, 2008 (JP) 2008-275569

(51) Int. Cl. H04N 7/01; H04N 5/66

(52) U.S. Cl. 348/448; 348/E07.003; 348/739; 348/E05.133

(57) ABSTRACT

According to one embodiment, a video display device includes a detection part configured to input a video signal to detect a black screen region in an effective display region from each of a plurality of frame images, a setting part configured to set a region to be processed excluding a black screen region from each of the frame images based on the detected result, a frame interpolation processing part configured to generate an interpolated image of each of a plurality of frames using adjacent frame images to which a region to be processed is set, and a display monitor configured to display a video signal subjected to a frame interpolation process. The video display device only performs a frame interpolation process on a necessary screen region by performing frame interpolation using an image from which a black screen region is separated.

### CROSS-REFERENCE TO RELATED APPLICATIONS

This application is based upon and claims the benefit of priority from Japanese Patent Application No. 2008-275569, filed Oct. 27, 2008, the entire contents of which are incorporated herein by reference.

### BACKGROUND

1. Field

One embodiment of the invention relates to a video display device, a video signal processing device, and a video signal processing method having a double-speed frame processing function of performing a frame interpolation process on a video signal to suppress image deletion caused by an afterimage in displaying video on a liquid crystal display device, for example.

2. Description of the Related Art

Recently, in the field of television receivers, liquid crystal display devices compatible with high-definition broadcasting are spreading rapidly. In the field of personal computers, liquid crystal display devices have become mainstream as display monitors, and digitally broadcast video can be viewed on personal computers equipped with a tuner compliant with digital broadcasting standards. However, because the response of liquid crystal elements is slow, frame loss due to the afterimage of a preceding frame occurs in video containing rapid movement. To solve this problem, a double-speed frame processing circuit for generating an interpolated frame between two consecutive frames is used (See Jpn. Pat. Appln. KOKAI Publication No. 2006-227235).

Also, in actual television broadcasting, standard television video with an aspect ratio of 4:3 may be inserted into a high-definition video signal with an aspect ratio of 16:9 and broadcast as a high-definition broadcast signal after adding black screen regions to both sides to adjust the ratio. In this case, the conventional technique for frame interpolation processes screen regions that do not need to be processed, which wastes power. Further, a screen edge process is performed on the black screen regions instead of the screen edges of the standard television video with the aspect ratio of 4:3, preventing an appropriate screen edge process from being performed (see Jpn. Pat. Appln. KOKAI Publication No. 2008-118620).

As described above, the conventional frame interpolation process has the problem of processing screen regions that do not need to be processed, and of performing a screen edge process on black screen regions and so preventing an appropriate screen edge process from being performed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating an embodiment of a liquid crystal television to which the present invention is applied;

FIG. 2 is a block diagram illustrating a more concrete configuration of an interpolated frame generation circuit of the above-described embodiment;

FIG. 3 is a flowchart illustrating a procedure of the interpolated frame generation circuit according to the above-described embodiment;

FIG. 4 is a conceptual diagram briefly illustrating the frame interpolation process;

FIG. 5 is a conceptual diagram illustrating an example of a malfunction according to the conventional method;

FIG. 6 is a conceptual diagram illustrating an example of a malfunction according to the conventional method;

FIGS. 7A and 7B are conceptual diagrams illustrating an example of conventional interpolated frame generation; and

FIGS. 8A and 8B are conceptual diagrams illustrating an example of interpolated frame generation according to the present invention.

### DETAILED DESCRIPTION

Various embodiments according to the invention will be described hereinafter with reference to the accompanying drawings. In general, according to one embodiment of the invention, a video display device comprises detection module configured to detect a black screen region in an effective display region from each of a plurality of frame images by inputting a video signal, region restriction module configured to restrict a black screen region of each of the frame images based on a result of detection by the detection module, frame interpolation processing module configured to perform a frame interpolation process of generating an interpolated image of each of a plurality of frames using previous and subsequent frame images restricted by the region restriction module, and display module configured to display a video signal subjected to the frame interpolation process.

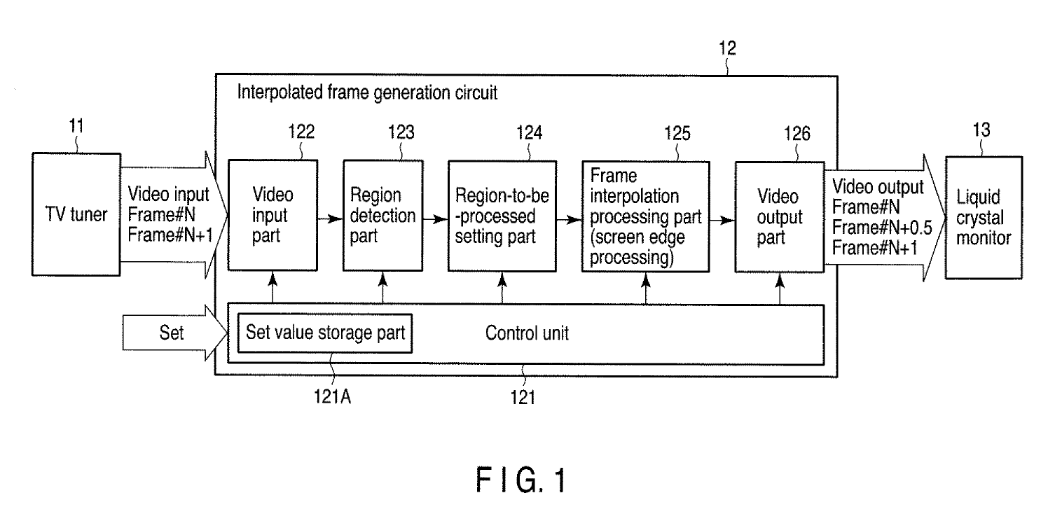

FIG. 1 is a block diagram illustrating an embodiment of a liquid crystal television to which the present invention is applied. Referring to FIG. 1, a TV tuner 11 selects a channel and demodulates a television broadcast signal received via an antenna (not shown) to obtain a video signal, an audio signal, and a data signal. The obtained video signal is supplied to an interpolated frame generation circuit 12. The interpolated frame generation circuit 12 includes a control part 121 for controlling internal operations. The control part 121 includes a set value storage part 121A for storing set values of various parameters specified from outside, and controls a process performed by each of a region detection part 123, a region-to-be-processed setting part 124, a frame interpolation processing part (including screen edge processing) 125, and a video output part 126, according to the set value stored in the set values storage part 121A.

A video signal supplied to the interpolated frame generation circuit 12 is supplied to a video input part 122. The video input part 122 inputs a video signal and holds previous and subsequent frames #N, #N+1. The region detection part 123 analyzes an image of each of the previous and subsequent frames #N, #N+1 held by the video input part 122 according to the set values stored in the set value storage part 121A to detect a region (such as a black screen region) that does not need to be processed. The region-to-be-processed setting part 124 sets a process region to be processed, on which a frame interpolation process is performed, for each of the previous and subsequent frame images, according to the result of detection by the region detection part 123. The frame interpolation processing part 125 performs a screen edge process on the regions to be processed in the images of the previous and subsequent frames #N, #N+1 set in the region-to-be-processed setting part 124 in the previous step to generate an image of an interpolated frame #N+0.5.

The generated image of the interpolated frame #N+0.5 is transmitted to the video output part 126 along with the images of the previous and subsequent frames #N, #N+1. The video output part 126 inserts the image of the interpolated frame #N+0.5 between the images #N, #N+1 of the previous and subsequent frames to generate a double-speed image, and outputs the double-speed image to a liquid crystal monitor 13.

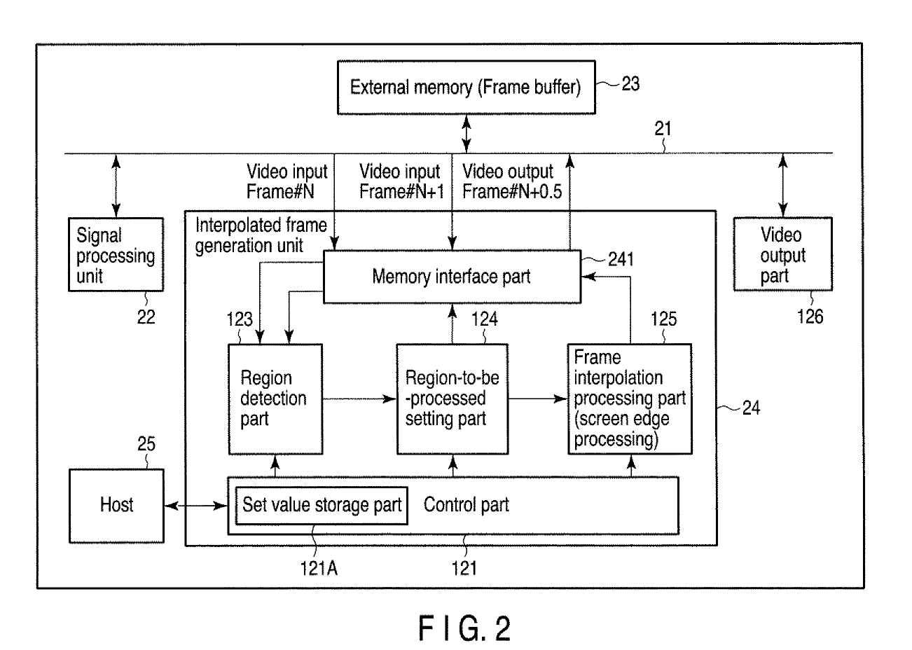

FIG. 2 is a block diagram illustrating a more concrete configuration of the interpolated frame generation circuit 12. In FIG. 2, the structural elements functionally same as those of FIG. 1 are denoted by the same reference numbers. Referring to FIG. 2, reference number 21 denotes a bus line for transmitting video signals, and a signal processing unit 22, an external memory (frame buffer) 23, an interpolated frame generation unit 24, a video output part 126 are connected to the bus line 21. The interpolated frame generation unit 24 includes a memory interface part 241 for inputting and outputting video signals having functions equivalent to those of the video input part 122 and the video output part 126 shown in FIG. 1 by frame, the control part 121 including the set value storage part 121A, the region detection part 123, the region-to-be-processed setting part 124, and the frame interpolation processing (including screen edge processing) part 125. The set value storage part 121A is connected to a host computer 25 for specifying set values.

In the configuration of FIG. 2, video is input and output through the memory interface part 241 in the interpolated frame generation unit 24. The host computer 25 sets various kinds of parameters and controls the overall system. The signal processing unit 22 processes a video signal received through broadcast waves or from an external video signal input terminal, for example, and transfers the video signal to an external memory (frame buffer) 23. The external memory (frame buffer) 23, which stores video data processed by each block, outputs current frame data (Frame #N+1) and previous frame data (Frame #N) to the interpolated frame generation unit 24 and captures interpolated frame data (Frame #N+0.5) from the interpolated frame generation unit 24. The video output part 126 sequentially reads the frame data (Frame #N, Frame #N+0.5, Frame #N+1) from the external memory (frame buffer) 23, and outputs the frame data to a liquid crystal monitor (not shown) via an external terminal, for example.

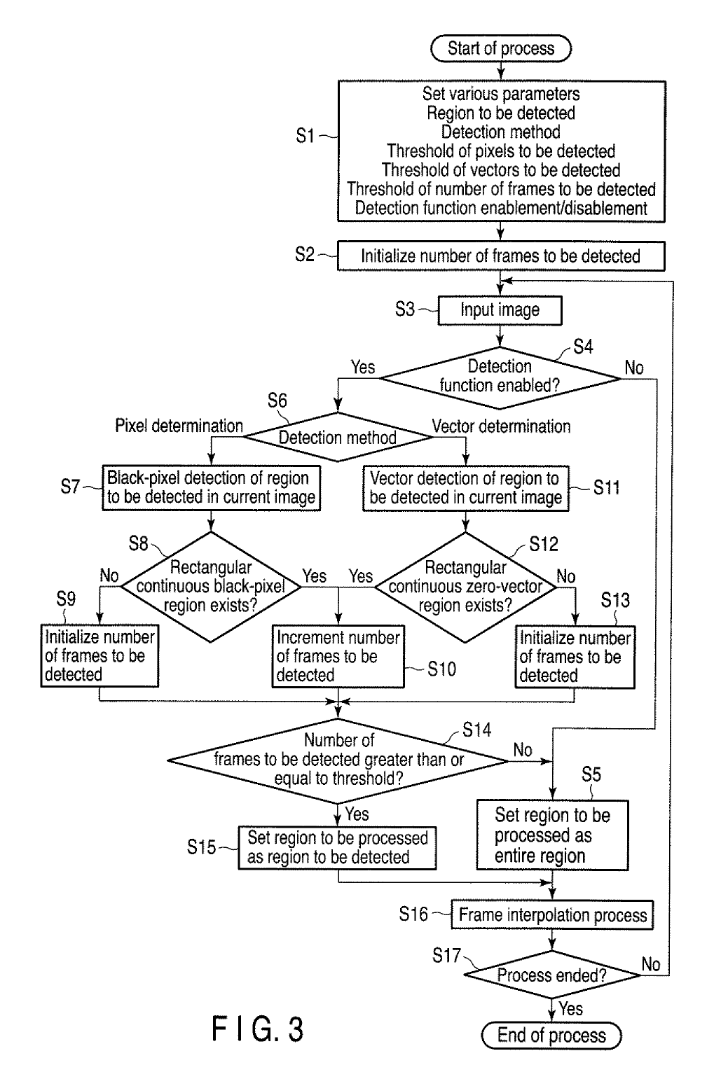

FIG. 3 is a flowchart illustrating a concrete procedure of the interpolated frame generation circuit 12 with the above-described configuration.

Before the start of an interpolated frame generation process by inputting an image, various parameters are set as default settings (step S1). This step includes setting of a region to be detected which will be subjected to a process for detecting screen edges, a detection method in black-screen determination or zero-vector determination, a threshold of pixels to be detected which will be used in detection for black-pixel determination, a threshold of vectors to be detected which will be used in detection for zero-vector determination, a threshold value of the number of frames to be detected for continuously detecting the same screen edge among a plurality of frames, and detection function enablement/disablement regarding whether to use the present detection function or not.

After completion of setting of the various parameters, the number of frames to be detected is initialized (step S2), and image input is started (step S3). After that, the detection function enablement/disablement is checked (step S4), and if the function is disabled, the screen edge detection is not performed and the entire region is set as a region to be processed (step S5). If the detection function is enabled, the detection method is checked (step S6).

If the detection method is the black-pixel determination method in step S6, a comparison is made between a pixel in a region to be detected in the current pixel and the threshold of pixels to be detected, and if the pixel exceeds the threshold, the threshold is determined as not being a black pixel (step S7). After that, it is checked whether the pixel determined as a black pixel forms a rectangular region continuously exists in horizontal and perpendicular directions (step S8). If a rectangular region does not exist, it is assumed that screen edges have not been detected in the current frame, and the number of frames to be detected is initialized (step S9). If a rectangular region exists, it is assumed that screen edges have been detected in the current frame and the number of frames to be detected is incremented (step S10).

If the detection method is the zero-vector determination method in step S6, a motion vector of each pixel in the region to be detected of the current image is detected using the current and previous images, for example (step S11). After that, a comparison is made between the detected vector and the threshold of vectors to be detected, and if the detected vector is less than or equal to the threshold, the detected vector is determined as a zero vector, and if the detected vector does not exceed the threshold value, the detected vector is determined as not being a zero vector. Step S12 also checks whether the pixel determined as a zero vector in the region to be detected forms a rectangular region which continuously exists in parallel and perpendicular directions. If a rectangular region does not exist, it is assumed that screen edges have not been detected in the current frame, and the number of frames to be detected is initialized (step S13). If a rectangular region exists, it is assumed that screen edges have been detected in the current frame, and the step proceeds to step S10, in which the number of detection frames is incremented.

After increment or initialization of the number of frames to be detected, the number of frames to be detected is compared with the threshold value of the number of frames to be detected (step S14). If the number of frames to be detected is less than the threshold, it is assumed that screen edge detection has not been sufficient, and the step proceeds to step S5, in which the entire region is set as a region to be processed. If the number of frames to be detected is greater than or equal to the threshold, it is assumed that detection of the screen edges has been completed, and the detected screen edges will be a region to be processed. After the region to be processed has been determined, a frame interpolation process is performed using edges of the region to be processed as screen edges (step S16), and the step returns to step S3 to continue processing of the next frame until an instruction to end the process is given.

The above-described method enables automatic detection of optimum screen edges and implementation of a screen edge process in generating frame interpolation using the detected screen edges.

Concrete examples of the process will be described below.

The present invention relates to a technique of improving performances by reducing the amount of processing of a double-speed frame processing circuit used in a liquid crystal television, for example. Displaying video on a liquid crystal television always involves the emission of colors while a frame is displayed, so that when another image is displayed in the next frame, the image displayed in the previous frame remains as a residual image. Accordingly, liquid crystal televisions are not good for displaying moving images. Recently, therefore, a double-speed frame technique of decreasing frame intervals and so decreasing afterimages by generating an image to be displayed at a time between two frames and displaying the generated image at such a time is often used.

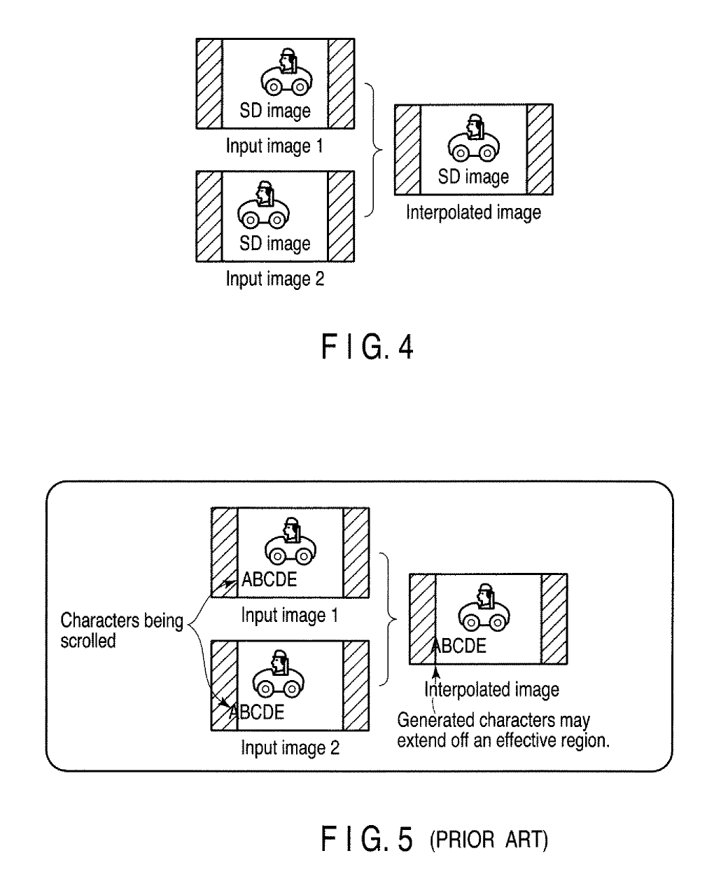

FIG. 4 is a conceptual diagram succinctly illustrating the frame interpolation process. Assume that the time at which an input image 1 is displayed is T1 and the time at which an input image 2 is displayed is T2. Since the car moves between the input images 1 and 2, the car is in different positions in the input images 1 and 2. An interpolated image, generated from the input images 1 and 2, is generated such that the position of the car is set between the positions of the input images 1 and 2. The relationship between a time Th at which the interpolated image is displayed and the times T1, T2 at which the adjacent input images are displayed is expressed by T1<Th<T2. This display decreases frame intervals and suppresses afterimages.

Although digital broadcasting is capable of transmitting high-definition (HD) video, which has high resolution, not all the video content has high resolution, and some of the content is standard-definition (SD) video, which has low resolution.

Some SD content is transmitted as HD video after black images have been added to the right and left edges of the SD image. A television will receive such content as HD video in terms of the reception signal, even though the underlying video is SD, and will perform various kinds of image processing on the video, assuming it to be HD. In most cases, image processing is performed on a region in which no image exists (more precisely, a black image), and so the processing is performed needlessly.

The same applies to the interpolated frame generation process. Further, the interpolated frame generation process is sometimes performed differently between image edges and other usual regions. In this case, an image edge process will be performed on an image edge of a video region which is originally a region of an SD image, but is different from the actual image edge because black has been added, which may degrade image edge processing performance.

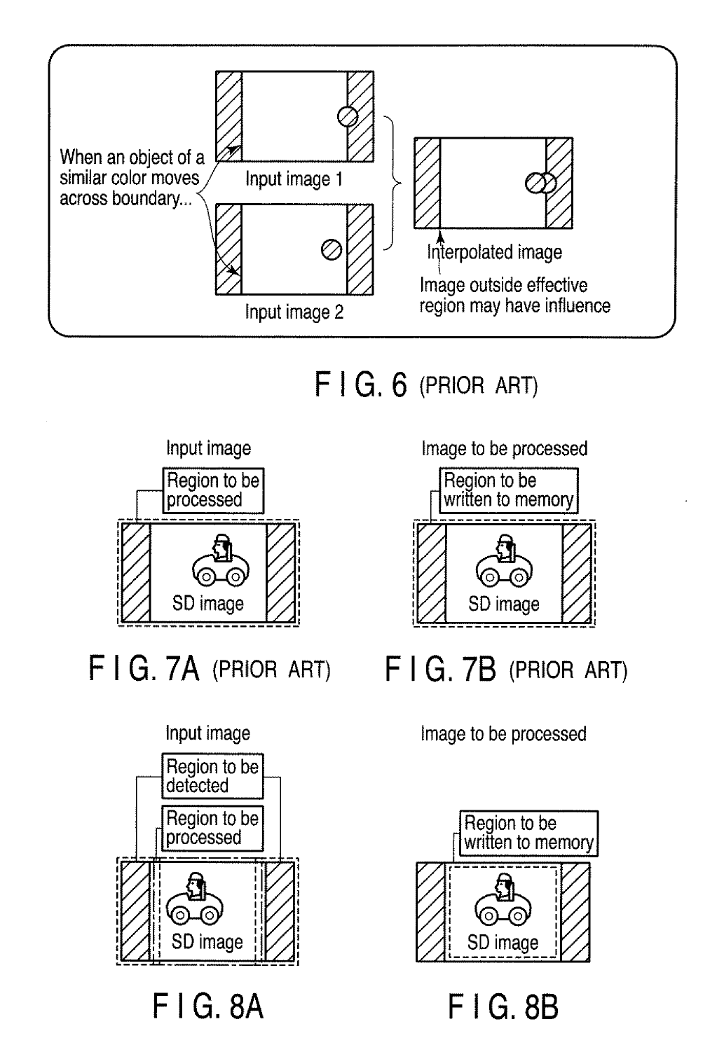

FIGS. 5 and 6 illustrate examples of malfunctions according to the conventional method. The example of FIG. 5 illustrates a state in which, when characters are displayed in an SD image being scrolled, an interpolated image is generated from input images 1, 2, and the characters generated from the characters being scrolled extend off an effective region of the SD image. The example of FIG. 6 illustrates a state in which, when a pattern of the same color as the color of the black screen region moves across a boundary between an edge of an SD image and the black screen region, an image (black screen region) outside an SD effective region affects the shape of the pattern.

When video including an interpolated frame in which such malfunctions occur is continuously displayed, the video will be unnatural and redundant processing will be performed. The present invention therefore presents a method capable of automatically determining, when SD video to which the black image is inserted is input as HD video, that the image is an SD image, to eliminate redundant processing and perform appropriate screen edge processing.

FIGS. 7A and 7B illustrate an example of the conventional interpolated frame generation, and FIGS. 8A and 8B illustrate an example of interpolated frame generation according to the present invention. Assuming that the entire image of an SD image, to which rectangular black image regions are added at both ends, is received as an HD image and input, as shown in FIG. 7A. In the conventional interpolated frame generation method, a region to be processed in an image is set as the overall image, which is the same as the input image.

In this case, since the entire region of the input image is set as a region to be subjected to a frame interpolation process, black regions are also subjected to the frame interpolation process, and a black interpolated image is generated from black regions of an image input prior to this image. Further, the region to be processed and the actual image edges (image edges of the SD image) are different. In this case, the boundary between the SD image and the black region is subjected to a usual frame interpolation process, which is not optimum screen edge processing and may degrade precision of an interpolated frame to be generated.

In the present invention, on the other hand, as shown in FIG. 8A, when the entire image of an SD image to which rectangular black images are added at both ends is received as an HD image and input, black screen regions are detected, and other portions are recognized as an SD image and set as a region to be processed. Further, after an interpolated frame is generated from the recognized SD image, black screen regions are added to return the image to the original image, as shown in FIG. 8B.

In this case, a region to be detected is set for the input image shown in FIG. 8A, as denoted by the dotted line.

After detecting a rectangular continuous black region in the region to be detected, the other region to be processed denoted by the dashed-dotted line is automatically set. That is, since the screen edges of the actual SD image and the screen edges of the image to be processed are coincident, it is possible to perform optimum screen edge processing, without deteriorating precisions of the interpolated frame to be generated as in the conventional example.

FIG. 8B shows that only the region (SD region) denoted by the dotted line needs to be written to an external memory (denoted by reference number 23 in FIG. 2) in the processed image. While the same black region is detected, black-region data outside the range needs to be written in advance to an external memory only once, thereby reducing the amount of memory access.

As described above, in the present embodiment, a video signal is input to detect a black screen region in an effective display region from each frame image, a black screen region is restricted in each of the frame images based on the result of detection of the black screen region, and an interpolated image of each frame is generated using restricted previous and subsequent frame images. Since frame interpolation can be performed based on an image from which black screen regions have been separated, a frame interpolation process can be performed on necessary and sufficient screen regions. Further, since a screen edge process can be performed on an image from which black screen regions have been separated, appropriate frame interpolation video can be obtained.

In the above-described example, the black-pixel detection approach and the zero-vector detection approach were shown as example approaches for detecting black screen regions added outside an SD region, but the present invention can be implemented by other arbitrary approaches too. The approach for detecting a zero vector is not limited to the one described above, and the present invention can be implemented by other arbitrary approaches too.

Further, the present invention can be implemented in a case where the region to be detected in the black screen region is top and bottom edges of the screen, as well as right and left edges of the screen. Moreover, the present invention is applicable to a case where the black image is added to regions other than the top and bottom edges or right and left edges, at the time of dual-screen display, multi-screen display, or data broadcast display, for example. Further, a plurality of regions may be set as the regions to be detected. Although other colors or patterns such as symbols or characters may be used as well as the color black, the present invention defines the region as a black screen region.

In the above-described embodiment, an interpolation process of generating one interpolated frame from two adjacent frames was described as an example, but the present invention is applicable to a case where two or more interpolated frames are generated from two or more adjacent frames.

Since the screen edge process of performing processing according to the detected screen edges may be applied not only to a specific screen edge process but also to various screen edge processes, the present invention omits detailed descriptions about the function of processing screen edges.

The above-described embodiment describes a case where the present invention is applied to a liquid crystal television, but the present invention is also applicable to display devices used in portable terminals or computer devices. Further, even when an interpolated frame generation circuit is integrated, the present invention can be embedded in the chip as a matter of course.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
a detection module configured to detect a black screen region in an effective display region from each of a plurality of frame images by inputting a video signal;
a restriction module configured to restrict a black screen region of each of the frame images based on a result of detection by the detection module;
an interpolation processing module configured to generate a video signal subjected to frame interpolation by generating an interpolated image of each of a plurality of frames using previous and subsequent frame images restricted by the restriction module; and
a display module configured to display a video signal generated by the interpolation processing module.

2. The video display device of claim 1, wherein the interpolation processing module performs a screen edge process by replacing an image of each of the frames having a black screen region restricted by the restriction module with a screen edge of the frame interpolation process.

3. A video signal processing device, comprising:
a detection module configured to detect a black screen region in an effective display region from each of a plurality of frame images by inputting a video signal;
a restriction module configured to restrict the black screen region of each of the frame images based on a result of detection by the detection module; and
interpolation processing module configured to generate a video signal subjected to frame interpolation by generating an interpolated image of each of a plurality of frames using previous and subsequent frame images restricted by the restriction module.

4. The video signal processing device of claim 3, wherein the interpolation processing module performs a screen edge process by replacing an image of each of the frames having a black screen region restricted by the restriction module with a screen edge of the frame interpolation process.

5. A video signal processing method, comprising:
detecting a black screen region in an effective display region from each of a plurality of frame images by inputting a video signal;
restricting a black screen region of each of the frame images based on a result of detection by the black screen region; and
generating a video signal subjected to frame interpolation by generating an interpolated image of each of a plurality of frames using the restricted previous and subsequent frame images.

6. The video signal processing method of claim 5, wherein the interpolation process performs a screen edge process by replacing each of the frame images having a restricted black screen region with a screen edge of the interpolation process.
